(19) United States
(12) Patent Application Publication
(10) Pub. No.: US 2022/0183360 A1
(43) Pub. Date: Jun. 16, 2022

(54) Electronic Cigarette with Wick

(71) Applicant: JT International S.A., Geneva (CH)

(72) Inventors: Paul Voerman, Apeldoorn (NL); Herman Hijma, Kampen (NL)

(73) Assignee: JT International S.A., Geneva (CH)

(21) Appl. No.: 17/431,548

(22) PCT Filed: Mar. 25, 2020
(86) PCT No.: PCT/EP2020/058423

§ 371 Date: Aug. 17, 2021

(30) Foreign Application Priority Data
Mar. 27, 2019 (EP) 19165588.5
Mar. 27, 2019 (EP) 19165593.5

(51) Int. Cl. A24F 40/44; A24F 40/42; A24F 40/10; A24F 40/485; A24F 40/46

(52) U.S. Cl. CPC A24F 40/44; A24F 40/42; F16K 15/044; A24F 40/485; A24F 40/46; A24F 40/10

(57) ABSTRACT

An electronic cigarette includes a power supply portion having a heater and a replaceable cartridge having a liquid store. The power supply portion has a fluid transfer element with an elongated shape including a first wicking part extending outwardly from the power supply portion as a free end, and a second wicking part configured to deliver liquid to the heater for vaporization. The power supply portion has a seating configured to fixedly attach to the second wicking part. The first wicking part is configured to extend into the liquid store when the power supply portion is connected to the cartridge. The replaceable cartridge is removably coupled to the power supply portion such that the first wicking part can be engaged and disengaged from the liquid store and, when disengaged, the fluid transfer element is a part of the power supply portion 3.

### FIELD OF INVENTION

The present disclosure relates to electronic cigarettes, and more specifically electronic cigarettes configured as a system adapted to receive disposable liquid cartridges.

### BACKGROUND

Electronic cigarettes and other aerosol inhalers or vaporisation devices are becoming increasingly popular consumer products.

In electronic cigarette products, an aerosol-forming, or vaporisable, substance is stored in a reservoir in liquid form. The reservoir typically has an outlet connected to a wicking or fluid transfer element which supplies the aerosol or vapour forming substance to a heater that vaporises the liquid aerosol or vapour forming substance.

Electronic cigarettes rely on the power stored locally in batteries, and there is a need to provide increased battery life for such devices. An object of the present invention is, therefore, to address such a challenge.

### SUMMARY

The foregoing object of the invention, as well as other problems, are addressed by the claims.

According to an aspect of the present disclosure, there is provided an electronic cigarette comprising a power supply portion comprising a heater, and a replaceable cartridge comprising a liquid store, wherein the replaceable cartridge further comprises a fluid transfer element comprising a first wicking part configured to extend into the liquid store and a second wicking part extending outwardly in a direction away from the liquid store and configured to fluidically couple the liquid store to the heater, wherein the fluid transfer element is configured to extend between the liquid store and the heater when the cartridge is connected to the power supply portion, and wherein the replaceable cartridge is removably coupleable to the power supply portion such that the second wicking part can be engaged and disengaged from the heater and, when disengaged, the fluid transfer element is a part of the cartridge.

In this way, only a portion of liquid in the second wicking part is heated. This stops heat unnecessarily spreading to the liquid store thereby improving the energy efficiency of the electronic cigarette. Preferably, the fluid transfer element is a wick, and the first and second wicking parts are toward opposite distal ends of the wick. Preferably, the wick is a single continuous wick with the first and second wicking parts toward opposite distal ends.

Preferably, the cartridge has a housing and a first end of the cartridge housing is configured as a first connection portion, the power supply portion having a housing and wherein a first end of the power supply portion housing is configured as a second connection portion, and the first connection portion of the cartridge housing is configured to connect to the second connection portion of the power supply portion.

In this way, an expired cartridge can easily be replaced with a new cartridge, and the power supply portion can be re-used.

Preferably, wherein the first connection portion is configured as a free end protruding from the cartridge housing and defining a cavity into which the second connection portion of the power supply portion is received.

In this way, the power supply portion can be easily guided into connection with the cartridge when a user wishes to, for example, replace an expired cartridge.

Preferably, the first connection portion is tubular and extends at least partially over the second wicking part.

In this way, a secure fit is provided between the power supply portion and the cartridge, and the second wicking part is easily guided to a correct position to fluidically couple the cartridge and the power supply portion. Furthermore, the extended length of the second wicking part is prevented from damage when the cartridge is not connected to the power supply portion, for example before connecting a new cartridge to the power supply portion, by a shielding provided by the tubular extension.

Preferably, the second connection portion of the power supply portion is configured as a free end, protruding from the power supply portion housing into which the first connection portion of the cartridge is received.

In this way, the cartridge can be easily guided into connection with the power supply portion when a user wishes to, for example, replace an expired cartridge. Preferably the free end protruding from the power supply portion is tubular.

Preferably, the housing of the cartridge comprises a second end opposite the first end, wherein the second end is configured as a mouthpiece portion.

In this way, when the cartridge is replaced the mouthpiece is also replaced; this removes the need for a user to clean the mouthpiece between cartridges.

Preferably, the cartridge comprises a flow tube having a first opening and a second opening, wherein the first opening is proximal to the second wicking part and the second opening is in the mouthpiece portion, such that vapour can pass from the second wicking part to the mouthpiece portion.

In this way, the generated vapour can reach the mouth piece by traversing the cartridge. This reduces the amount of vapour and condensation to pass through the inhaler device and any potential condensation will be left in the cartridge.

Preferably, the power supply portion comprises a receiving cavity, configured to receive the second wicking part, and wherein the receiving cavity is tubular with the heater arranged on the inner surface of the receiving cavity.

In this way, the second wicking part is efficiently heated by the heater to vaporise liquid held in the second wicking part as the heater can heat the extent of the second wicking part surrounded by the tubular cavity.

Preferably, the receiving cavity has openings arranged to allow vapour to pass therethrough.

In this way, the vaporised liquid can move away from the heater such that further liquid stored within the second wicking part can migrate to a surface region of the wick to be heated and released from the second wicking part as a vapour.

Preferably, the openings are in the form of slits.

In this way, the vaporised liquid can move away from the heater whilst maintaining a respectively large area of the tubular cavity for heating the second wicking part.

Preferably, the heater is a spirally coiled heater attached to an inner surface of the receiving cavity.

In this way, the heater can surround the second wicking part to provide an efficient heating of the second wicking part. Additionally, this arrangement is simple to manufacture.

Preferably, the heater forms at least a part of the receiving cavity.

In this way, the heater can surround the second wicking part to provide an efficient heating of the second wicking part. Additionally, this arrangement is robust as the heater elements are not exposed.

Preferably, the receiving cavity comprises a ceramic body with integrated resistive heating wires.

In this way, heat is provided to the second wicking part without an exposed heating element coming into direct contact with the second wicking part.

Preferably, there is a gap between the heater and the second wicking part when the second wicking part is located inside the heater.

In this way there is a vaporization space between the heater and the wicking part, which lets vapour form and escape.

Preferably, the liquid store comprises a porous element, wherein the porous element is arranged to transfer liquid to the fluid transfer element.

In this way, liquid is efficiently transferred from the inside of the cartridge to the fluid transfer element. Preferably the porous material is a fibrous material such as polyester fiber.

According to another aspect of the present disclosure, there is provided a cartridge for an electronic cigarette, the cartridge comprising a liquid store, wherein the cartridge further comprises a fluid transfer element comprising a first wicking part extending into the liquid store and a second wicking part extending outwardly in a direction away from the liquid store and configured to fluidically couple the liquid store to a heater in an electronic cigarette, wherein the fluid transfer element is configured to extend between the liquid store and the heater when the cartridge is connected to the electronic cigarette, and wherein the cartridge is removably coupleable to the electronic cigarette such that the second wicking part is engageable and disengageable from the heater.

In this way, a cartridge is provided for which only a portion of liquid in the second wicking part is heated. This stops heat unnecessarily spreading to the liquid store thereby improving the energy efficiency of an electronic cigarette using the cartridge. Preferably, the fluid transfer element is a wick, and the first and second wicking parts are toward opposite distal ends of the wick. Preferably, the wick is a single continuous wick with the first and second wicking parts toward opposite distal ends.

Preferably, the cartridge includes the features of the preceding aspect, where appropriate.

According to another aspect of the present disclosure, there is provided an electronic cigarette comprising a power supply portion comprising electrical circuitry and a heater, and a replaceable cartridge comprising a liquid store, wherein the power supply portion further comprises a fluid transfer element having an elongated shape, the fluid transfer element comprises a first wicking part extending outwardly from the power supply portion as a free end and a second wicking part configured to deliver liquid to the heater for vaporization, and wherein the power supply portion comprises a seating configured to fixedly attach to the second wicking part of the fluid transfer element and wherein the first wicking part is configured to extend into the liquid store when the power supply portion is connected to the cartridge, and wherein the replaceable cartridge is removably coupleable to the power supply portion such that the first wicking part can be engaged and disengaged from the liquid store and, when disengaged, the fluid transfer element is a part of the power supply portion.

In this way, only a portion of liquid in the second wicking part is heated. This stops heat unnecessarily spreading to the liquid store thereby improving the energy efficiency of the electronic cigarette.

Preferably, the fluid transfer element is an elongated wick, and the first wicking part and the second wicking part are respectively located at two opposite distal ends of the elongated wick.

In this way, liquid from the liquid store is efficiently transferred to the heater.

Preferably, the heater at least partially surrounds the second wicking part of the fluid transfer element.

In this way, liquid held in the second wicking part is effectively vaporised.

Preferably, the cartridge has a housing and a first end of the cartridge housing is configured as a first connection portion, the power supply portion has a housing and wherein a first end of the power supply portion housing is configured as a second connection portion, and the first connection portion of the cartridge housing is configured to connect to the second connection portion of the power supply portion.

In this way, an expired cartridge can easily be replaced with a new cartridge, and the power supply portion can be re-used.

Preferably, the second connection portion is configured as a free end protruding from the power supply portion into which the first connection portion of the cartridge is received.

In this way, the cartridge can be easily guided into connection with the power supply portion when a user wishes to, for example, replace an expired cartridge.

Preferably, the second connection portion is tubular and extends at least partially over the first wicking part.

In this way, a secure fit is provided between the power supply portion and the cartridge, and the first wicking part is easily guided to a correct position to fluidically couple the cartridge and the power supply portion. Furthermore, the extended length of the first wicking part is prevented from damage when the power supply portion is not connected to the cartridge, for example before connecting a new cartridge to the power supply portion, by a shielding provided by the tubular extension.

Preferably, the first connection portion is configured as a free end, protruding from the cartridge housing into which the second connection portion of the power supply portion is received.

In this way, the cartridge can be easily guided into connection with the power supply portion when a user wishes to, for example, replace an expired cartridge. Preferably the free end protruding from the cartridge is tubular.

Preferably, there is a gap between the second wicking part and the heater.

In this way, a vaporisation space is created which enables vapour to form and be transported away from the heater. Also it reduces the residual build up on the heater as it is not in direct contact with the wick.

Preferably, the power supply portion further comprises a vaporization chamber, and wherein the cartridge further comprises a flow tube extending through the liquid store to a mouthpiece such that vapour can pass from the vaporisation chamber to the mouthpiece.

In this way, the generated vapour can reach the mouth piece by a simple mechanism. It is better to transport liquid through the consumable to capture any condensation in the consumable. It is also cleaner as the vapour is passing through a disposable part, rather than in the re-usable main device.

Preferably, the cartridge comprises a closable opening configured to be opened upon engagement with the first wicking part of the fluid transfer element and wherein the closable opening of the cartridge is closed when the cartridge is disconnected from the power supply portion.

In this way, liquid can be inhibited from escaping the cartridge when the power supply portion is not connected. This reduces the likelihood of leaks. Preferably the closable opening is a valve. Alternatively the closable opening comprises a septum or membrane.

Preferably, the closable opening comprises a valve, wherein the valve is biased to a closed position.

In this way, leakage from the cartridge is inhibited.

Preferably, the valve comprises a channel extending into the liquid store from the closable opening with at least one aperture in housing of the channel arranged to provide a fluid connection between the channel and the liquid store, a closing member and a biasing member arranged to bias the closing member to close the closable opening, wherein the channel is arranged to receive the first wicking part such that receiving the first wicking part pushes the closing member inward to the liquid store and compresses the biasing member, such that liquid can flow from the liquid store by the at least one aperture to the first wicking part received in the channel.

Preferably, the liquid store comprises a porous element, wherein the porous element is arranged to transfer liquid to the fluid transfer element.

In this way, liquid is efficiently transferred from the inside of the cartridge to the fluid transfer element. Preferably the porous material is a fibrous material such as polyester fiber.

Preferably, the fluid transfer element is removable from the seating of the power supply portion such that the fluid transfer element can be replaced.

Preferably, the fluid transfer element is removable from the seating of the power supply portion and the heater such that the fluid transfer element can be replaced.

In this way, an expired fluid transfer element, or wick, can be replaced.

Preferably, the heater and the fluid transfer element are mounted on a support that is removable from the seating of the power supply portion such that the fluid transfer element and the heater can be replaced.

In this way, an expired fluid transfer element, or wick, can be replaced along with the heater at regular intervals.

### BRIEF DESCRIPTION OF THE DRAWINGS

Embodiments of the invention are now described, by way of example, with reference to the drawings, in which:

FIG. 1 shows a perspective view of an electronic cigarette in an embodiment of the present invention;

FIGS. 2a and 2b show a schematic perspective view and a cross-sectional view of an electronic cigarette with a wicking part extending from the cartridge;

FIG. 2c shows a cross-sectional view of an electronic cigarette with a wicking part extending from the cartridge;

FIGS. 3a and 3b show a schematic perspective view and a cross-sectional view of electronic cigarette according to an alternative arrangement to FIGS. 2a and 2b;

FIGS. 3c and 3d show a schematic perspective view and a cross-sectional view of electronic cigarette according to an alternative arrangement to FIGS. 2a 2b and 2c, and 3a and 3b.

FIGS. 4a to 4c show schematic cross-sectional diagrams of a liquid store;

FIGS. 5a and 5b show a schematic perspective view and a cross-sectional view of an electronic cigarette with a wicking material extending from the main body of the electronic cigarette;

FIGS. 6a and 6b show diagrams of a wicking material being received in a liquid store;

FIGS. 7a and 7b show schematic cross-sectional diagrams of a valve arrangement for application in a cartridge;

FIGS. 8a and 8b show schematic cross-sectional diagrams of another valve arrangement for application in a cartridge;

FIGS. 9a to 9d show schematic cross-sectional diagrams of another valve arrangement for application in a cartridge;

FIG. 10 shows a schematic cross-sectional diagram of a cartridge 5 for use with an electronic cigarette;

FIGS. 11a and 11 b show schematic cross-sectional diagrams of a removable wick;

FIGS. 12a and 12b show schematic cross-sectional diagrams of a removable heater and wick;

FIG. 13 shows a perspective view of a coiled wire type heater embedded in a support;

FIG. 14 shows a cross-sectional diagram of a liquid store and wick engaged with the heater of FIG. 13;

FIGS. 15a and 15b show diagrams of a heater;

FIGS. 16a to 16c show diagrams of a ring-type heater;

FIGS. 17a and 17b show an alternate wick arrangement that can be used with the ring-type heater of FIGS. 16a to 16c; and

FIGS. 18a to 18c show cross-sectional diagrams of alternative device structures of an electronic cigarette with a main body, cartridge and vapour flow tube.

### DETAILED DESCRIPTION

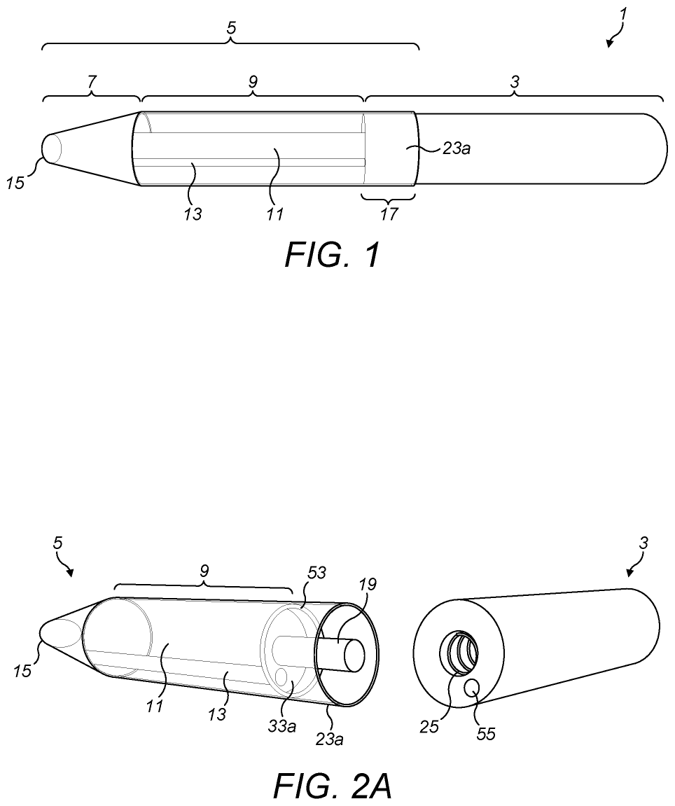

FIG. 1 shows an electronic cigarette 1 according to an embodiment of the present invention having a main body 3 and a cartridge 5.

The main body 3 can be considered as a power supply portion having a power supply, or battery, and a heater 25. The heater 25 is arranged to vaporise liquid 11 from the cartridge 5.

The cartridge 5 has a liquid store 9, containing the vaporisable liquid 11. A mouthpiece portion 7 is arranged at a first distal end of the liquid store 9. The second distal end of the liquid store 9, opposite the first distal end, is arranged for engagement with the main body 3. The mouthpiece portion 7 has an orifice 15 through which vapour can be inhaled by a user. Generated vapour is delivered to the orifice 15, from the heater 25, by a vapour flow tube 13. The vapour flow tube 13 has a first end proximal to the heater 25 and extends through the liquid store 9 with a second end connected to the orifice 15.

The main body 3 may be reusable, whereas the cartridge 5 may be a disposable/replaceable consumable.

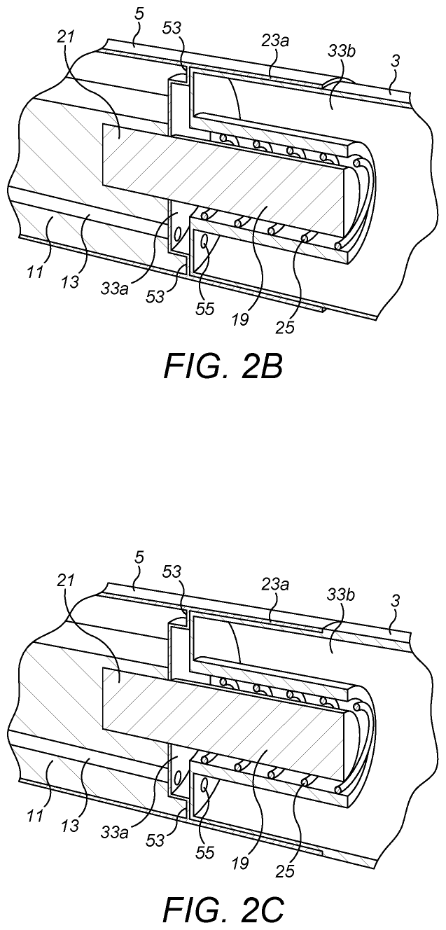

As best seen in FIGS. 2a and 2b, the main body 3 and the cartridge 5 are connectable to one another. The cartridge 5 has a free end 23a forming a recess into which the housing of the main body 3 is received. The free end 23a of the cartridge 5 is formed to the same cross-sectional shape as the liquid store 9 of the cartridge 5 and extends from the liquid store 9. The internal diameter of the free end 23a of the cartridge 5 is approximately equal to the external diameter of the main body 3 such that when the main body 3 is guided into the free end 23a of the cartridge 5 a snug fit is achieved. The free end 23a of the cartridge 5 then forms an overlap region 17 over the main body 3 securing the main body 3 in connection with the cartridge 5.

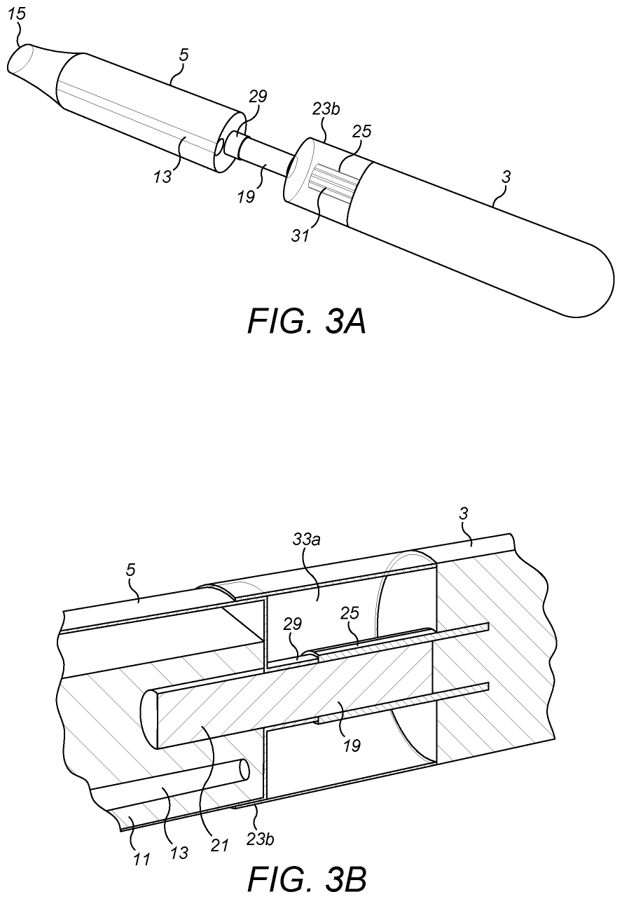

Alternatively, as illustrated in FIGS. 3a and 3b, the main body 3 may have a free end 23b forming a recess into which a part of the cartridge 5 is received. The free end 23b of the main body 3 is formed to the same cross-sectional shape as the main body 3 and extends from the main body 3. In this example, the internal diameter of the free end 23b of the main body 3 is approximately equal to the external diameter of the cartridge 5 such that when the cartridge 5 is guided into the free end 23b of the main body 3 a snug fit is achieved. The free end 23b of the main body 3 then forms an overlap region 17 over the cartridge 5 securing the cartridge 5 in connection with the main body 3.

In the example shown, the cartridge 5 and main body 3 have a circular cross-section. In other examples, the cross section may triangular, quadrilateral, pentagonal, hexagonal, or any other appropriate shape.

The sidewalls of the liquid store 9 may be transparent or translucent so that a user can monitor the amount of liquid 11 in the liquid store 9. Alternatively, the sidewalls of the liquid store 9 may be opaque.

The cartridge 5 and main body 3 have a housing that can be made from any robust material, such as plastic or metal. If the cartridge 5 is to be a disposable consumable, it is preferable that it is made from a low-cost, recyclable plastic.

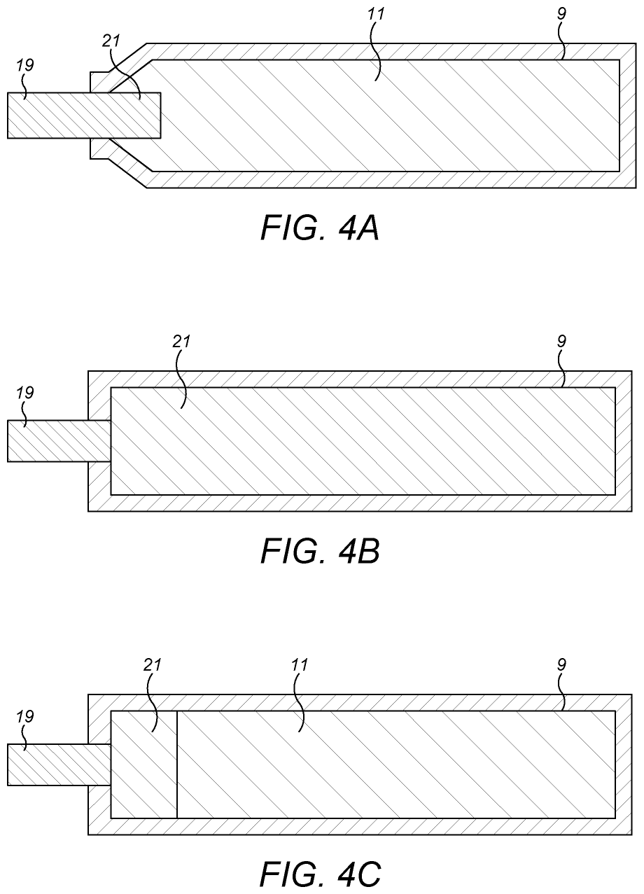

In some embodiments, as described subsequently with reference to FIGS. 2 and 3 for example, a fluid transfer element, or wicking material, extends from within the liquid store 9 of the cartridge 5 outwardly to form a free end for engagement in a heater 25 in the main body 3. Hence, the elongate wicking element is stationary attached to the cartridge 5. In other embodiments, also described subsequently with reference to FIG. 5 for example, a fluid transfer element, or wicking material, extends from within a heater 25 in the main body 3 outwardly to form a free end for engagement in the liquid store 9 of the cartridge 5.

The fluid transfer element or wick is preferably a heat resistant material, with a rigid structure and fast liquid transport properties. The material is advantageously a fibrous or porous material, such as cotton, natural fibres, silica fibres or ceramics.

FIGS. 2a and 2b show an electronic cigarette with the features as described with reference to FIG. 1, wherein a wick has a protruding end extending outwardly from the cartridge 5.

As described with reference to FIG. 1, the cartridge 5 of FIGS. 2a and 2b has a free end 23a forming a recess into which the main body 3 is received. The free end 23a of the cartridge 5 is formed to the same cross-sectional shape as the liquid store 9 of the cartridge 5 and extends from the liquid store 9. The internal diameter of the free end 23a of the cartridge 5 is approximately equal to the external diameter of the main body 3 such that when the main body 3 is guided into the free end 23a of the cartridge 5 a snug fit is achieved. The free end 23a of the cartridge 5 then forms an overlap region over the main body 3 securing the main body 3 in connection with the cartridge 5. This creates a stability to withstand torsion and bending in the connection joint between the cartridge and the main body.

The wicking material 19, 21 can be formed of a single piece; a first end portion of the wicking material 21 (i.e. a first wick part or portion 21) extends inwardly to the liquid store 9 of the cartridge 5. The first wick portion 21 may be arranged in a seating inside the liquid store 9. A second end portion of the wicking material 19 (i.e. a second wick part or portion 19) extends outwardly from the liquid store 9 of the cartridge 5, forming a free end. Hence, the first wick portion 21 is configured as a liquid uptake portion and a second wick portion 19 is configured as a liquid delivery portion. In this way, liquid 11 in the liquid store 9 is drawn out by a wicking action provided by the wicking material and under influence of the vaporisation at the heater, and held in the wicking material. As such, the wicking material provides a fluid connection between the liquid store 9 and the heater 25.

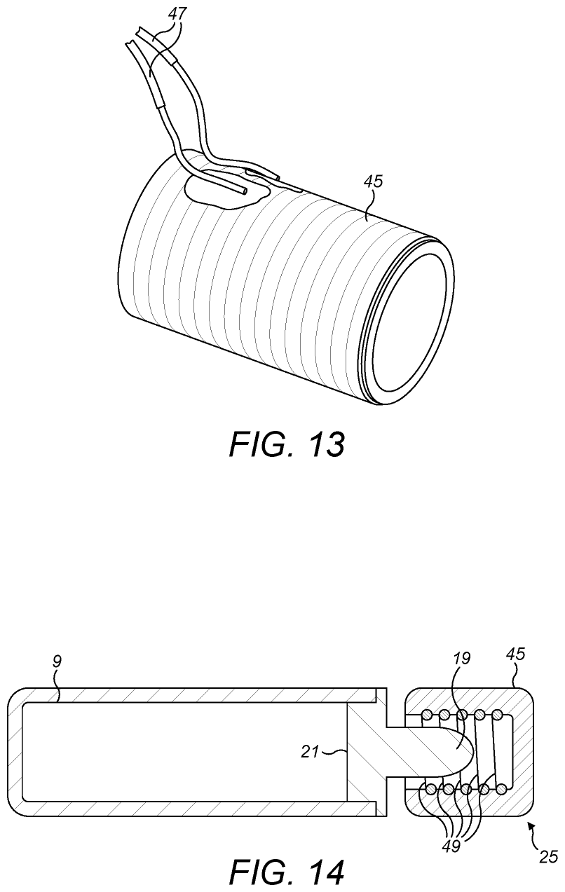

When the cartridge 5 and main body 3 are brought into connection with one another, the second wick portion 19 is received in the heater 25 such that the heater 25 forms a heating cavity that surrounds the second wick portion 19. In an example the heater is a coiled wire with an internal diameter matching the external diameter of the wicking material. Other examples of heaters are described with reference to FIGS. 13 to 17. The wicking material has a cross-sectional shape that corresponds to the insider of the heater 25. For example, as shown in FIGS. 2a and 2b, the heater 25 defines a cylindrical cavity into which the first end of the wicking material 19 is received.

The heater 25 is arranged to apply heat energy to the second wick portion 19. This vaporises the liquid held in the second wick portion 19, generating a vapour. The second wick portion 19 has a smaller diameter than the cavity of the heater 25 such that a gap is formed between the two. This gap allows the outflow of vapour generated by the heater 25 heating the liquid in the second wick portion 19.

The aforementioned snug connection provided between the main body 3 and the cartridge 5, by the free end 23a (or 23b in the case that the free end extends from the main body 3) provides for an alignment of the second wick portion 19 in the heater 25 such that the second wick portion 19 is held centrally in the heater 25.

Additionally, a rotating lock can also be provided in the connection between the cartridge and the main body. The rotating lock can be provided as a threaded connection or a bayonet coupling.

The main body 3 having the heating cavity and the cartridge 5 are separated such that vapour from the heating cavity can reach the vapour flow tube 13.

For example, as illustrated in FIG. 2b, a stopper 53 may be provided such that a flush connection between the cartridge 5 and main body 3 avoided. The stopper is thus separating the cartridge 5 from the main body such that a vapour receiving cavity 33a is defined between the cartridge 5 and the main body 3.

The vapour receiving cavity 33a takes the form of an annular groove in the surface of the cartridge 5 that faces the main body 3 when the cartridge 5 and main body 3 are engaged. Edges of the annular groove form the stopper 53 by abutting the surface of the main body 3 the faces the cartridge 5 when the main body 3 and cartridge 5 are brought into engagement.

Optionally, the vapour can flow from the heater 25 into a vapour cavity within the main body 3. The surface of the main body 3 into which the heating cavity extends (i.e. the surface of the main body 3 that faces the cartridge 5) may also include an aperture 55 that allows the outflow of vapour in the vapour cavity 33b such that vapour can exit the vapour cavity 33b. The vapour can then pass through the aperture 55 from the vapour cavity 33b in the main body, into the vapour cavity 33a between the surfaces of the main body 3 and the cartridge 5 such that vapour can be drawn through the aperture and into the vapour flow tube 13 when a user draws on the mouthpiece.

In the examples shown in FIGS. 2a and 2b, the heater 25 is a coiled wire type heater 25. Other heater types may also be used, as described subsequently; any heater arrangement described herein can be used with the embodiment of FIGS. 2a and 2b where appropriate.

In the arrangement shown in FIGS. 2a and 2b, the recessed free end 23a of the cartridge 5 can be dimensioned to be equal to (or greater than) the length of the second wick portion 19. That is, the free end 23a extends outwardly from the cartridge 5 at least an equal axial length to the second wick portion 19. In this way, the free end 23a can provide a shielding for the second wick portion 19, reducing the likelihood of damage to the wick. In alternative embodiments, a free end can instead extend from the main body 3 rather than the cartridge 5, as is described with reference to FIGS. 3a and 3b.

In an alternative embodiment, FIG. 2c shows an electronic cigarette with features corresponding to those of FIGS. 2a and 2b, the only differences being that the end of the main body 3 arranged to be received in the recessed free end 23a of the cartridge is of a narrower external diameter than the remaining portion of the main body 3; the remaining portion of the main body 3 has an external diameter approximately equal to the external diameter of the cartridge 5. That is, the end of the main body 3 arranged to engage the cartridge 5 has an external diameter approximately equal to the internal diameter of the recessed free end 23a of the cartridge 5, and the remaining portion of the main body 3 has an external diameter approximately equal to the external diameter of the cartridge 5. Consequently, when the main body 3 and the cartridge 5 are engaged, the external diameter of the electronic cigarette is consistent over its entire length.

FIGS. 3a and 3b show diagrams of an alternate arrangement to the example of FIGS. 2a to 2c. Again, the second wick portion 19 extends outwardly from the cartridge 5, and the first wick portion 21 extends inwardly to the liquid store 9 in the cartridge 5.

In the embodiment shown in FIGS. 3a and 3b, a free end 23b forming a recess extends from the main body 3. The free end 23b of the main body 3 is formed to the same cross-sectional shape as the main body 3. In this example, the internal diameter of the free end 23b of the main body 3 is approximately equal to the external diameter of the cartridge 5 such that when the cartridge 5 is guided into the free end 23b of the main body 3 a snug fit is achieved. The free end 23b of the main body 3 then forms an overlap region over the cartridge 5 securing the cartridge 5 in connection with the main body 3.

The heater 25 of FIGS. 3a and 3b is arranged as a free end extending outwardly from the surface of the main body 3 arranged to face the cartridge 5. The heater 25 is cylindrical in shape in the axial longitudinal direction, the inside of the cylinder forming a heating cavity. The cylindrical heater 25 has an internal diameter suitable for receiving the second wick portion 19. That is the internal diameter of the heater 25 is greater than or equal to the external diameter of the second wick portion 19. When the main body 3 and cartridge 5 are brought into connection with one another, the second wick portion 19 is accommodated in the heater 25.

The first wick portion 21, extending into the liquid store 9, wicks liquid 11 from the liquid store 9 to the second wick portion 19. The second wick portion 19 wicks the liquid to heater 25. That is, the wick 19, 21 including the first 21 and second 19 wick portions wicks the liquid 11 from the liquid store 9 to the heater 25 in a manner corresponding to that as described with reference to FIGS. 2a to 2c.

The heater 25 of FIGS. 3a and 3b has a series of grooves 31 running along the length of the heater 25. These grooves 31 allow for the outflow of vapour generated when the heater 25 heats the vapour held in the second wick portion 19.

When the cartridge 5 and main body 3 are engaged, a vapour cavity 33a is defined by a separation between the surface of the main body 3 that the heater 25 extends from, and the surface of the cartridge 5 that the wick extends from. This separation is caused by the distal end of the second wick portion 19 abutting the bottom of the heating cavity.

When the heater 25 vaporises the liquid held in the second wick portion 19, the vapour flows through the grooves 31 and into the vapour cavity 33a. The vapour can then be drawn from the vapour cavity 33a into the vapour flow tube 13 to the mouthpiece orifice 15 when user draws on mouthpiece 7 (as described with reference to FIGS. 2a to 2c).

The free end 23b, extending from the main body 3, is dimensioned to be equal to or greater in length the than the heater 25. In this way, the free end provides shielding to the heater 25 thereby reducing the likelihood of damage to the heater 25.

A collar 29 is provided to secure the second wick portion 19 to the cartridge 5. The collar 29 surrounds a based end of the second wick portion 19 where it extends from the cartridge 5. This is beneficial as it inhibits bending of the second wick portion 19 which could lead to damage to the wick.

In alternate arrangement the heater 25 of FIGS. 2a to 2c could be used with the embodiment of FIGS. 3a and 3b. In another alternate arrangement, the free end that extends from the cartridge 5 as described with reference to FIGS. 2a and 2b could instead be used with the embodiment of FIGS. 3a and 3b. Moreover, it is noted that the heater arrangements of FIGS. 2a, 2b, 2c and 3a, 3b (or FIGS. 3c and 3d as described subsequently) can be used interchangeably, as can the free end arrangements for connection between the main body 3 and cartridge 5, i.e. either of the heater arrangements and either of the free end arrangements can be used with either embodiment. Any heater arrangement described herein can be used with the embodiment of FIGS. 3a and 3b where appropriate.

FIGS. 3c and 3d show an electronic cigarette with an alternative arrangement to that of FIGS. 3a and 3b. The electronic cigarette of FIGS. 3c and 3d has features corresponding to those of FIGS. 3a and 3b, the only differences being that the end of the cartridge 5 arranged to be received recessed free end 23b of the main body 3 is of a narrower external diameter than the remaining portion of the cartridge 5; the remaining portion of the main cartridge 5 has an external diameter approximately equal to the external diameter of the main body 3. That is, the end of the cartridge toward the mouthpiece has a larger external diameter than the connection portion arranged to engage the main body 3. The connection portion of the cartridge 5 arranged to engage the main body has an external diameter approximately equal to the internal diameter of the recessed free end 23b of the main body 3, whereas the remaining portion of the cartridge 5 has an external diameter approximately equal to that of the main body 3. Consequently, when the main body 3 and the cartridge 5 are engaged, the external diameter of the electronic cigarette is consistent over its entire length.

The electronic cigarette arrangements of FIGS. 2a, 2b, 3a, 3b, 3c and 3d, are advantageous as the maximum amount of liquid held in the second wick portion 19 defines a maximum amount that the heater 25 need heat at a given time. Moreover, the size of the second wick portion 19 can be dimensioned such that it holds only enough liquid for one puff of vapour. This portion control allows for a restriction of the amount of liquid that is heated and consequently provides power saving in that no excess liquid in unnecessarily heated such as in the case of heating a larger reservoir of liquid to generate vapour. As a smaller amount of liquid is heated, i.e. an amount corresponding to one puff, less energy input is required to elevate the temperature of the liquid to its vaporisation point. Furthermore, the use of the wicking material inhibits heat transfer to the liquid 11 in the liquid store 9, reducing wasted heat energy and improving the efficiency of the electronic cigarette. This improved efficiency can result in an increased battery life.

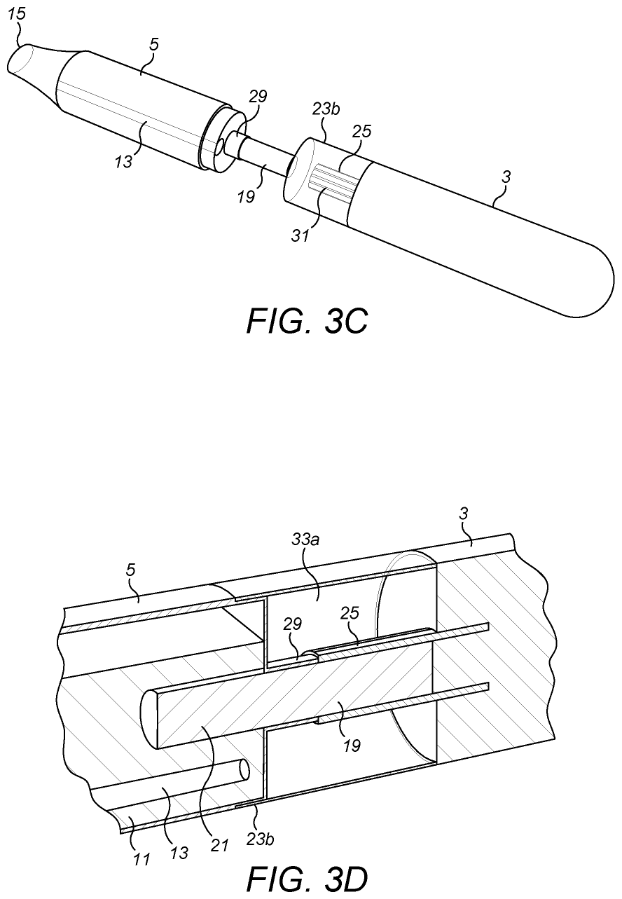

FIGS. 4a-4c show cross-sectional diagrams of various arrangements of the liquid store 9, second wick portion 19 and first wick portion 21 in the cartridge 5.

FIG. 4a shows a cross-sectional diagram of a liquid store 9 in which the liquid 11 is contained as a free liquid. The second wick portion 19 extends outwardly from the liquid store 9, and the first wick portion 21 extends inwardly to the liquid store 9. The second wick portion 19 and first wick portion 21 form a single wick 19, 21. The first wick portion 21 is in fluid connection with the freely contained liquid 11 in the liquid store 9 such that it can absorb the liquid 11 and wick it to the second wick portion 19.

FIG. 4b shows a cross-sectional diagram of a liquid store 9 in which the liquid 11 is contained by being held in a saturated fibrous or porous material. The saturated material may be, for example, a polyester and/or polypropylene fibre and may be porous in nature. The saturated fibre material is in fluid connection with the second wick portion 19; the saturated fibre material can act as the first wick portion 21 and wick the liquid to the second wick portion 19 which extends outwardly from the liquid store 9.

FIG. 4c shows a cross-sectional diagram of a liquid store 9 in which the liquid 11 is contained partially as a free liquid and partially in a saturated fibre material. The saturated fibre material is arranged inside the liquid store 9 at an end of the liquid store 9 from which the second wick portion 19 extends. Liquid 11 is contained freely in the remaining volume of the liquid store 9. In this case, the saturated fibre material can act as the first wick portion 21 and absorbs the freely contained liquid 11 from the remaining volume of the liquid store 9. The second wick portion 19 is in fluid connection with the saturated fibre material, such that the saturated fibre material wicks liquid to the second wick portion 19.

FIGS. 5a and 5b show diagrams of an electronic cigarette with features as described with reference to FIG. 1, wherein an elongate wick extends outwardly from the main body 3.

In FIGS. 5a and 5b, the main body 3 has a recessed free end 23b extending from the main body 3. The free end 23b of the main body 3 is formed to the same cross-sectional shape as the main body 3. In this example, the internal diameter of the free end 23b of the main body 3 is approximately equal to the external diameter of the cartridge 5 such that when the cartridge 5 is guided into the free end 23b of the main body 3 a snug fit is achieved. The free end 23b of the main body 3 then forms an overlap region over the cartridge 5 securing the cartridge 5 in connection with the main body.

Optionally, the cartridge housing may be provided with a smaller diameter in the connection portion and a larger diameter in the direction towards the mouthpiece outlet. That is, the end of the cartridge 5 for connection to the main body 3 has an external diameter approximately equal to the internal diameter of the recessed free end 23b of the main body 3, and the remaining portion of the cartridge 5 has an external diameter approximately equal to the external diameter of the main body 3. In this way, the outer diameter of the electronic cigarette can be consistent over its length.

In an alternative arrangement, the free end can extend from the cartridge 5 (similar to that in FIGS. 1, 2a and 2b) into which the main body 3 is received. The free end of the cartridge 5 is formed to the same cross-sectional shape as the liquid store 9 of the cartridge 5 and extends from the liquid store 9. The internal diameter of the free end of the cartridge 5 is approximately equal to the external diameter of the main body 3 such that when the main body 3 is guided into the free end of the cartridge 5 a snug fit is achieved. The free end of the cartridge 5 then forms an overlap region 17 over the main body 3 securing the main body 3 in connection with the cartridge 5.

In another alternative arrangement the free end can extend from the cartridge 5 (similar to that in FIG. 2c) into which the main body 3 is received. In this arrangement the end of the main body 3 arranged to be received in the recessed free end of the cartridge is of a narrower external diameter than the remaining portion of the main body 3; the remaining portion of the main body 3 has an external diameter approximately equal to the external diameter of the cartridge 5. That is, the end of the main body 3 arranged to engage the cartridge 5 has an external diameter approximately equal to the internal diameter of the recessed free end 23a of the cartridge 5, and the remaining portion of the main body 3 has an external diameter approximately equal to the external diameter of the cartridge 5. Consequently, when the main body 3 and the cartridge 5 are engaged, the external diameter of the electronic cigarette is consistent over its entire length.

The wicking material can be formed of a single piece 19, 21. A first end portion of the wicking material 21 (i.e. a first wick portion 21) extends outwardly from the main body 3, forming a free end. A second end portion of the wicking material 19 (i.e. a second wick portion 19) extends inwardly to the main body 3, fixed in a seating 41 in the main body 3, and is arranged in connection with the heater 25. When the cartridge 5 and main body 3 are brought into connection with one another, the first wick portion 21 is received through an opening 30 in the cartridge 5 such that the first wick portion 21 enters the liquid store 9. The liquid store 9 may include a seating for receiving the first wick portion 21. In this way, liquid 11 in the liquid store 9 is drawn out by a wicking action provided by the first wick portion 21; the wicking action transfers the liquid through the wick to the second wick portion 19 in contact with the heater 25. As such, the wicking material provides a fluid connection between the liquid store 9 and the heater 25.

An optional collar 29 surrounds the opening 30 to the liquid store 9. The collar supports 29 the first wick portion 21 when it is received through the opening 30.

As described with reference to FIG. 1, the cartridge 5 has a liquid store 9, containing a vaporisable liquid 11. A mouthpiece portion 7 is arranged at a first distal end of the liquid store 9. The second distal end of the liquid store 9, opposite the first distal end, is arranged for engagement with the main body 3. The mouthpiece portion 7 has an orifice 15 through which vapour can be inhaled by a user. Generated vapour is delivered to the orifice 15, from the heater 25, by a vapour flow tube 13. The vapour flow tube 13 has a first end proximal to the opening 30 of the cartridge 5; consequently, when the main body 3 and the cartridge 5 are connected to one another the first end of the vapour flow tube 13 is proximal to the heater 25. The vapour flow tube 13 extends through the liquid store 9 with a second end connected to the orifice 15.

The arrangements of the liquid store 9 described with reference to FIGS. 4a to 4c may be used with the electronic cigarette of the FIGS. 5a and 5b as appropriate.

FIG. 5b shows a coiled wire heater 25 surrounding the second wick portion 19. The heater 25 is arranged in a vapour cavity 33b within the main body 3, wherein the vapour cavity 33b is arranged with receive the vapour generated by the heater 25. The heater 25 generates a vapour by vaporising liquid held in the second wick portion 19, transferred from the liquid store 9 by the combination of the second wick portion 19 and the first wick portion 21. The vapour flows from the heater 25 and wick into the cavity 33b. An aperture 55 is arranged in the surface of the main body 3 that faces the cartridge 5 such that the vapour can exit the vapour cavity 33b. The aperture may align with the vapour flow tube 13 such that vapour can be drawn through the aperture and into the vapour flow tube 13 when a user inhales on the mouthpiece 7.

Optionally, a chamber 33a can be arranged in the connection between the cartridge 5 and the main body 3. The chamber 33a is configured to collect the vapour from the heater 25 and wick and transport it through the vapour flow tube 13. The chamber 33a is advantageously located in the cartridge 5 as an annular groove in the surface of the cartridge 5 facing toward to the main body 3 when the cartridge 5 and main body 3 are engaged with one another, with the vapour flow tube inlet provided in the groove. Edges of the annular groove form a stopper 53 by abutting the surface of the main body 3 the faces the cartridge 5 when the main body 3 and cartridge 5 are brought into engagement. The stopper 53 prevents the surfaces of the cartridge 5 and main body 3 that face one another from being pushed completely together to form a flush connection when the cartridge 5 and main body 3 are brought into engagement with one another thereby defining the vapour receiving cavity or chamber 33a between the two surfaces.

A seal 39, in the form of a collar 39, surrounds the base of the first wick portion 21 where it extends from the main body 3. This provides a connection between the wick and the main body 3, and supports the wick.

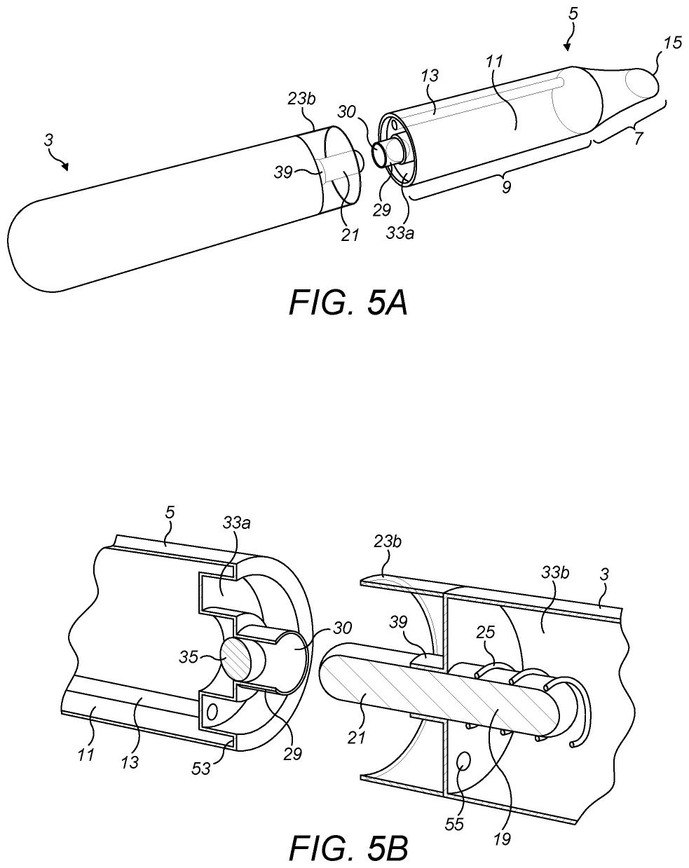

Optionally, a valve 35 can be arranged in the opening 30 to the liquid store 9. The valve 35 allows for the first wick portion 21 to enter the liquid store 9 by passing through the opening 30 and for the egress of liquid 11 from the liquid store 9 as it is wicked through the wicking material when the first wick portion 21 is arranged in the liquid store 9. The valve 35 prevents the egress of liquid 11 from the liquid store 9 when the first wick portion 21 is not inserted into the liquid store 9. The valve 35 is described in more detail subsequently with reference to FIGS. 6 to 9.

FIG. 6a shows a diagram of the wick 19, 21 approaching the opening 30 to the liquid store 9. FIG. 6b shows a diagram of the first wick portion 21 inserted through the opening 30 such that the valve 35 is in an open position and the first wick portion 21 is in connection with the liquid 11 in the liquid store 9.

A coiled heating wire type heater 25 surrounds the second wick portion 19 and is arranged in an optional support 37. In this case, the heating wire is embedded in the support 37. The seal 39 secures the wick in the support 37. The opening 30 to the liquid store 9 is closed by the valve 35. For clarity, the remaining portions of the main body 3 and cartridge 5 are not shown in FIGS. 6a and 6b.

When the first wick portion 21 presses against the valve 35, the valve 35 opens and the first wick portion 21 moves into the liquid store 9. The first wick portion 21 contacts liquid 11 within the liquid store 9 and wicks it through the wick to the second wick portion 19 where it is heated by the heater 25 such that the liquid vaporises. In this way, the heater 25 only has to provide enough power to heat the relatively small amount of liquid in the second wick portion 19 to vaporisation, rather than heating the larger volume of liquid 11 in the liquid store 9 to generate a vapour.

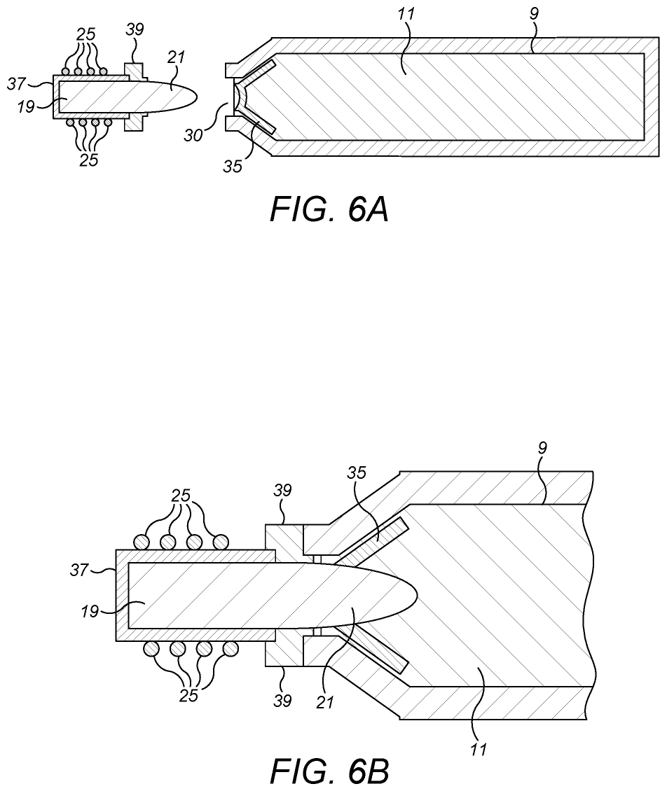

FIGS. 7a and 7b show cross-sectional diagrams of a valve 35 arrangement for application in the cartridge 5 shown in FIGS. 5a, 5b, 6a and 6b. The valve 35 has a closing member 56, for example a ball, which is biased toward a closed position (as shown in FIG. 7a) by a biasing member 54, for example a spring. In the closed position the opening 30 in the cartridge 5 is closed-off by the closing member 56.

The closing member 56 is arranged in a channel 51 with an open first end (corresponding to the opening 30 in the cartridge 5) and a closed second end 52, at an opposite end of the channel 51 to the first end 30, against which the biasing member 54 is supported. The channel may be tubular in shape.

The channel 51 has, at the first end proximal to the opening 30, a projection 60 which projects partially inward to the channel 51 to provide a narrowing of the channel proximal to the opening 30. The closing member 56 is pushed against the projection 60 by the biasing member 54 such that the closing member 56 abuts the projection 60 when in the closed position. The projection 60 may be one continuous projection around the inner surface of the channel 51 such as a flange, defining a narrow passage 62 at the opening 30 of the cartridge 5. The diameter of the closing member 56 is greater than the width of the narrow passage 62 so that liquid cannot escape the channel 51 when the closing member 56 is abutting the projection 60, but also so that the closing member 56 is not pushed out of the channel 51 by the biasing member 54.

The channel 51 further has at least one aperture 58 in a sidewall 50; a sidewall 50 being a wall of the channel 51 that is perpendicular to the first and second ends 30, 52 of the channel. The at least one aperture 58 allows liquid 11 in the liquid store 9 to flow into the channel 51. When the closing member 56 is in the closed position, the closing member 56 abutting the projection 60 inhibits liquid 11 exiting the cartridge 5 by the opening 30. That is, the closing member 56 blocks the flow of liquid 11 out of the cartridge 5 as it is arranged between the at least one aperture 58 and the opening 30.

As shown in FIG. 7b, when the cartridge 5 and the main body 3 are brought into connection, the first wick portion 21 is inserted through the narrow passage 62 defined by the projection 60 and engages the closing member 56. The first wick portion 21 pushes the closing member 56 along the channel 51 in a direction away from the opening 30 by overcoming the biasing provided by the biasing member 54. When the closing member 56 passes the at least one aperture 58 as it is pushed toward the second end 52 of the channel 51, liquid 11 in the liquid store 9 can flow into the channel 51 and exit the opening 30; thus defining the open position of the valve 35. That is, the closing member 56 is no longer arranged between the at least one aperture 58 and the opening 30; rather, the at least one aperture 58 is arranged between the opening 30 and the closing member 56. The presence of the first wick portion 21 in the channel 51 means that, rather than the liquid 11 freely flowing from the opening 30, it is absorbed by the first wick portion 21. The first wick portion 21 wicks the liquid 11 out of the cartridge 5 to the second wick portion 19 engaged by the heater 25. In this way, the wick opens the valve 35 and transports liquid 11 from the cartridge 5 to the heater 25.

When the cartridge 5 and main body 3 are disengaged, the first wick portion 21 moves out of the channel and the biasing member 54 pushes the closing member 56 back to the closed position, abutting the projection 60, thereby preventing liquid 11 from escaping the liquid store 9.

In an alternative arrangement, the aperture 58 may be in the second end 52 of the channel 51; in this case a flange-type abutment can extend inwardly to the channel 51 proximal to the second end 52 of the channel 51, against which the biasing member 54 is supported.

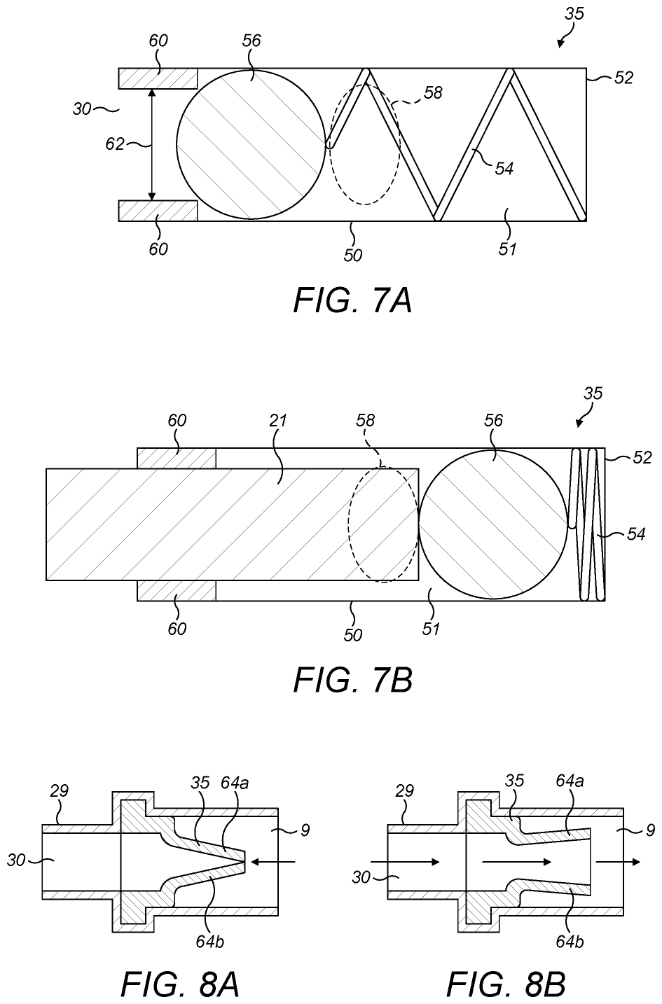

FIGS. 8a and 8b show another valve 35 arrangement suitable for application in the cartridge 5 shown in FIGS. 5a, 5b, 6a and 6b. The valve 35 has two sheets 64a, 64b of a resilient elastomer material. The sheets 64a, 64b have first end portions fixed to opposite sides of the opening 30, and second end portions (opposite the first end portions) which are free ends biased toward one another in a ‘duck bill’ type of arrangement. The biasing together of the free ends of the sheets 64a, 64b closes the valve 35 and prevents liquid 11 exiting the liquid store 9 by the opening 30, as shown in FIG. 8a depicting the closed position of the valve 35.

When the cartridge 5 and the main body 3 are brought into connection with one another, the first wick portion 21 passes between the sheets 64a, 64b toward the free ends of the sheets 64a, 64b and overcomes the biasing together of the sheets 64a, 64b at the free ends, thereby deforming the sheets 64a, 64b. The first wick portion 21 can then pass through the valve 35 and enter the liquid store 9, as shown in FIG. 8b depicting the open position of the valve 35. It is noted that the first wick portion 21 is not shown so that the deformation of the sheets 64a, 64b can be clearly seen.

The first wick portion 21 absorbs liquid 11 in the liquid store 9 and wicks the liquid 11 out of the cartridge 5 to the second wick portion 19 engaged by the heater 25. In this way, the wick opens the valve 35 and transports liquid 11 from the cartridge 5 to the heater 25.

By virtue of the biasing together of the sheets 64a, 64b, when the first wick portion 21 is arranged between the sheets 64a, 64b in the open position, the sheets 64a, 64b are biased against the first wick portion 21 thereby securing the wick in position in the cartridge 5.

When the cartridge 5 and the main body 3 are disengaged from one another, the first wick portion 21 is removed from the valve 35 and the biasing together of the free ends of the sheets 64a, 64b returns the valve 35 to the closed position, as shown in FIG. 8a. This prevents the egress of liquid 11 from the liquid store 9.

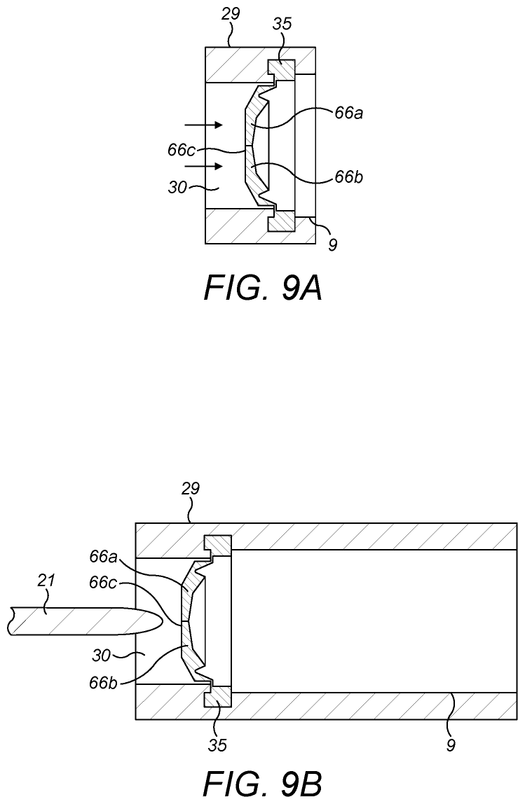

FIGS. 9a to 9d show another valve 35 arrangement suitable for application with the cartridge 5 shown in FIGS. 5a, 5b, 6a and 6b. The valve 35 is an ‘X-fragm’ type valve with two sheets 66a, 66b of a resilient elastomer with first end portions fixed to opposite sides of the opening 30, and second end portions (opposite the first end portions) which are free ends biased toward one another and together. In this way, the sheets 66a, 66b form a substantially planar surface 66c that prevents the egress of liquid 11 from the liquid store 9 through the opening 30 when in the closed position as shown in FIGS. 9a and 9b.

When the cartridge 5 and the main body 3 are brought into connection with one another, the first wick portion 21 presses against the substantially planar surface 66c and deforms the sheets 66a, 66b. The sheets 66a, 66b are thus separated by the force applied by the first wick portion 21 overcoming the biasing together of the sheets 66a, 66b. The first wick portion 21 can then pass between the sheets 66a, 66b and thus through the valve 35 and into the liquid store 9. This results in the valve 35 being in an open position as depicted in FIGS. 9c and 9d. It is noted that the first wick portion 21 is not shown in FIG. 9c to more clearly show the deformation of the sheets.

By passing through the valve 35 and being positioned in the liquid store 9, the first wick portion 21 can absorb liquid 11 contained in the liquid store 9. The first wick portion 21 wicks the liquid 11 out of the cartridge 5 to the second wick portion 19 engaged by the heater 25. In this way, the wick opens the valve 35 and transports liquid 11 from the cartridge 5 to the heater 25.

By virtue of the biasing together of sheets 66a, 66b, as with the valve 35 in the arrangement of FIGS. 9a and 9b, when the first wick portion 21 is arranged between the sheets 66a, 66b the sheets 66a, 66b are biased against the first wick portion 21 thereby securing the wick in position in the cartridge 5.

When the cartridge 5 and main body 3 are disengaged from one another the first wick portion 21 is removed from the valve 35. As such, the biasing together of the free ends of the sheets 66a, 66b returns the valve 35 to the closed position by reforming the substantially planar surface 66c as shown in FIGS. 9a and 9b. This prevents the egress of liquid 11 from the liquid store 9.

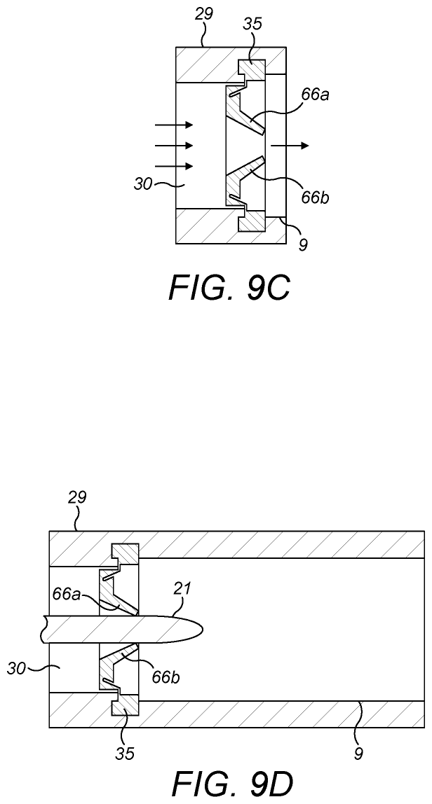

The cartridge 5 can be a disposable/replaceable consumable. FIG. 10 shows a cross-sectional diagram a cartridge 5 for use with the electronic cigarette of FIGS. 5a, 5b, 6a and 6b. The cartridge 5 has a valve 35, the valve 35 can be any suitable type of valve 35 including those described in FIGS. 7a, 7b, 8a, 8b and 9a to 9d. The cartridge 5 further includes a tamper evident seal 43, for example a heat induction seal. The seal 43 must be removed before the first use of the cartridge 5. The provision of the seal 43 allows the user to know that the cartridge 5 is new and has not been tampered with.

Although the cartridge 5 has been described as a disposable or replaceable consumable, in some embodiments, the cartridge 5 may be a refillable and re-usable cartridge 5. In this way, the valve 35 arrangements of FIGS. 7a, 7b, 8a, 8b and 9a to 9d can be used with a refilling device attached to a liquid reservoir in much the same way as the first wick portion 21, but for transferring liquid into the liquid store 9 rather than out, for example in a pipette type arrangement.

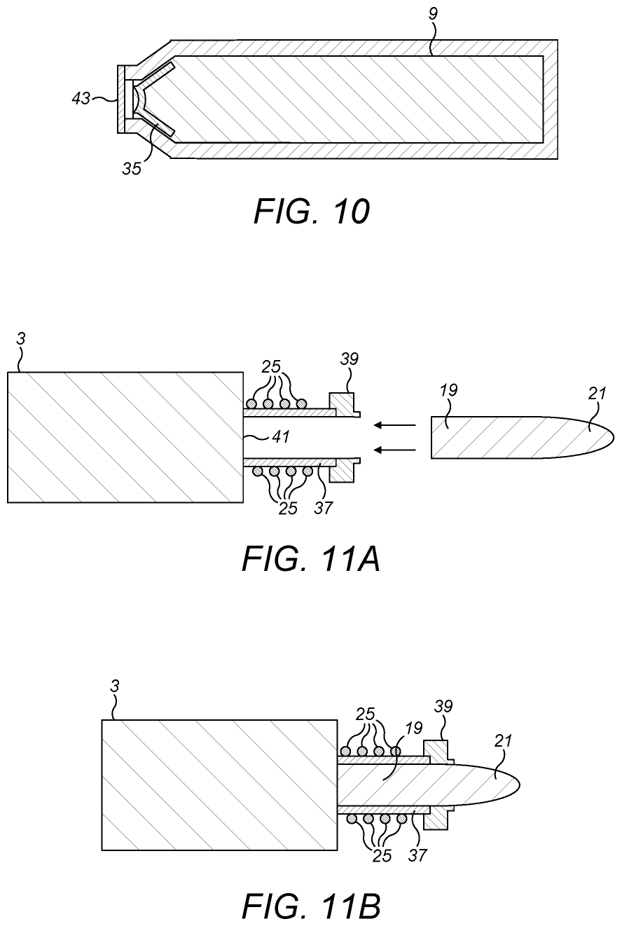

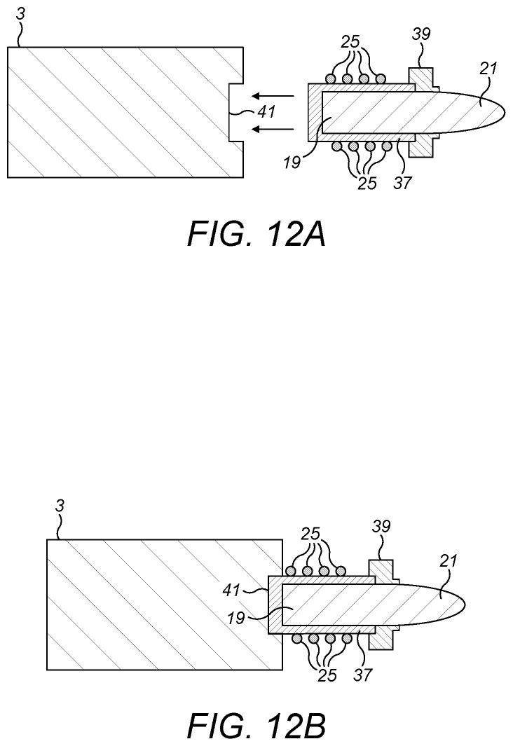

In some examples, the wick 19, 21, or the heater 25 and the wick 19, 21 are removable from the main body 3, as shown in FIGS. 11a and 11b and FIGS. 12a and 12b, respectively.

FIG. 11a shows a diagram of the removable wick 19, 21 separated from the main body 3 and the heater 25, and FIG. 11b shows the wick received in the heater 25 in the main body 3. In this example, the heater 25 is a wire-type heater embedded in a support 37 fixed to the main body 3 of the electronic cigarette, although other heater arrangements described herein may equally be used where appropriate. A seating 37 is provided into which the wick is received such that the second wick portion 19 is surrounded by the heater 25 and the first wick portion 21 extends outwardly from the heater 25. A seal 39 surrounds the base of the first wick portion 21 that extends from the heater 25 so as to secure the wick in the heater 25. The arrangement of FIGS. 11a and 11 b is beneficial as an expired wick can be replaced.

FIGS. 12a and 12b show an example in which both the wick 19, 21 and the heater 25 are mounted on a support 37 removable from the main body 3 of the electronic cigarette. FIG. 12a shows the removable heater 25 and wick separated from the main body 3 of the electronic cigarette. In this example, the heater 25 is a wire-type heater 25 embedded in, or mounted on, a support 37. Other heater arrangements described herein may equally be used where appropriate. The heater 25 surrounds the second wick portion 19 and the first wick portion 21 extends outwardly from the heater 25. A seal 39 surrounds the base of the first wick portion 21 that extends from the heater 25 so as to secure the wick in the heater 25. The support 37 is received in a seating 41 in the main body 3 of the electronic cigarette. When mounted in the seating 41, as shown in FIG. 12b, an electrical connection is made between the heater 25 and the power supply in the main body 3. The arrangement of FIGS. 12a and 12b is beneficial as both an expired wick 19, 21 and heater 25 can be replaced.

The following describes various heater arrangements suitable for application with the aforementioned electronic cigarettes and wicks.

FIG. 13 shows a diagram of a coiled wire type heater 25 embedded in a support 37. The support 37 is preferably a ceramic casing 45, although any other suitable type of electrically insulating material may be used. The heater 25 is cylindrical in shape with an open end arranged to receive a portion of a wick. The heater 25 is connectable to a power supply in the main body 3 of the electronic cigarette by way of a wired connection 47.

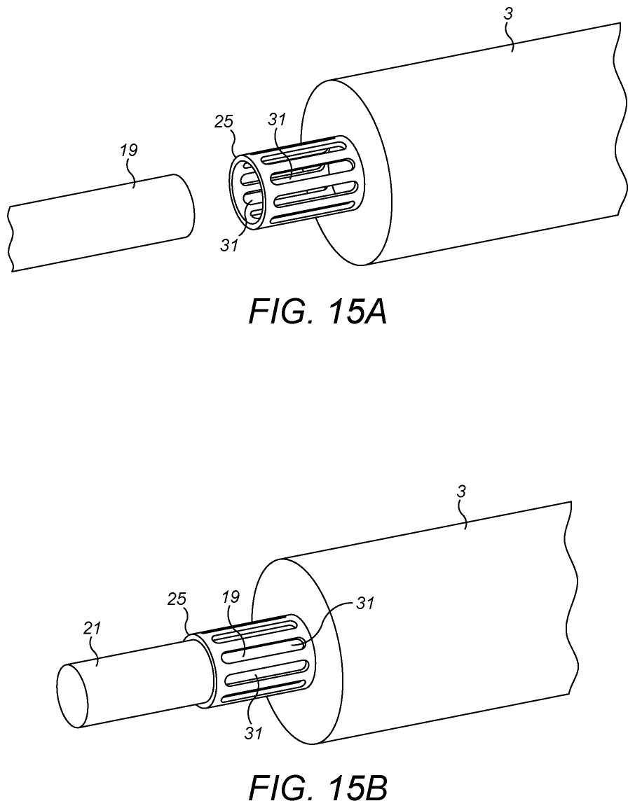

FIG. 14 shows a cross-sectional diagram of a liquid store 9 and wick 19, 21 engaged with the heater 25 of FIG. 13. In this example the first wick portion 21 extends into the liquid store 9 where it absorbs liquid 11 stored therein and wicks it to the substantially cylindrical second wick portion 19 surrounded by the cylindrical heater 25. The heating wires 49 apply heat to the second wick portion 19 and vaporise the liquid held in the second wick portion 19. The external diameter of the second wick portion 19 is smaller than the internal diameter of the cylindrical heater 25. In this way gaps are provided between the sides of the second wick portion 19 and the heater 25 so that the generated vapour can escape. The heater 25 and second wick portion 19 need not be cylindrical, but could be any shape that would allow the second wick portion 19 to be arranged within the heater 25.

In another example, the wick could be fixed to extend from the heater 25 of FIG. 13 in an embodiment in which the wick extends from the main body 3 of the electronic cigarette.

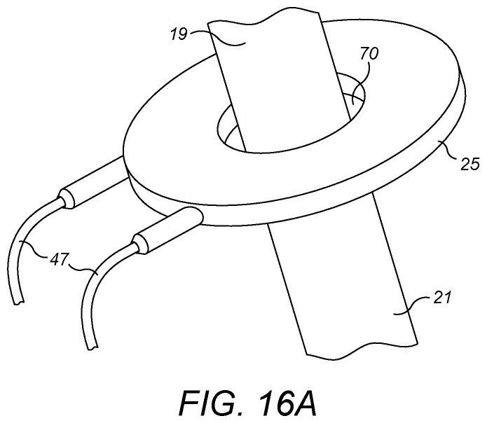

FIGS. 15a and 15b show more detailed diagrams of the heater 25 described with reference to FIGS. 3a and 3b. FIG. 15a shows the wick 19, 21 and heater 25 separated, and FIG. 15b shows the wick having been received in the heater 25.

The heater 25 extends as a free end from the main body 3 of the electronic cigarette and is cylindrical in shape. The cylindrical heater 25 has an open end dimensioned to receive the second wick portion 19 which is substantially cylindrical in shape. The external diameter of the second wick portion 19 is approximately equal to the internal diameter of the heater 25 such that a close fit between the second wick portion 19 and the heater 25 is achieved when the second wick portion 19 is received in the heater 25.

The sidewall(s) of the cylindrical heater 25 (perpendicular to the open end) have a series of vapour releasing grooves 31 along their length. The grooves 31 form openings through which vapour can escape after having been generated when the heater 25 vaporises the liquid held in the second wick portion 19.

Although not shown in FIGS. 15a and 15b, the first wick portion 21 (at the end of the wick opposite the second wick portion 19) would extend into the liquid store 9 in the cartridge 5 in order to wick liquid from the liquid store 9 to the second wick portion 19 and hence the heater 25. The cartridge 5 (and liquid 11 store therein) is not shown so that the heater 25 can be seen more clearly. The free end 23b which connects the main body 3 to the cartridge 5 (as described with reference to FIGS. 3a and 3b) is not shown so that the heater 25 can be seen more clearly.

It is noted that the heater 25 need not be cylindrical, but could be any shape that would allow the second wick portion 19 to be received within the heater 25.

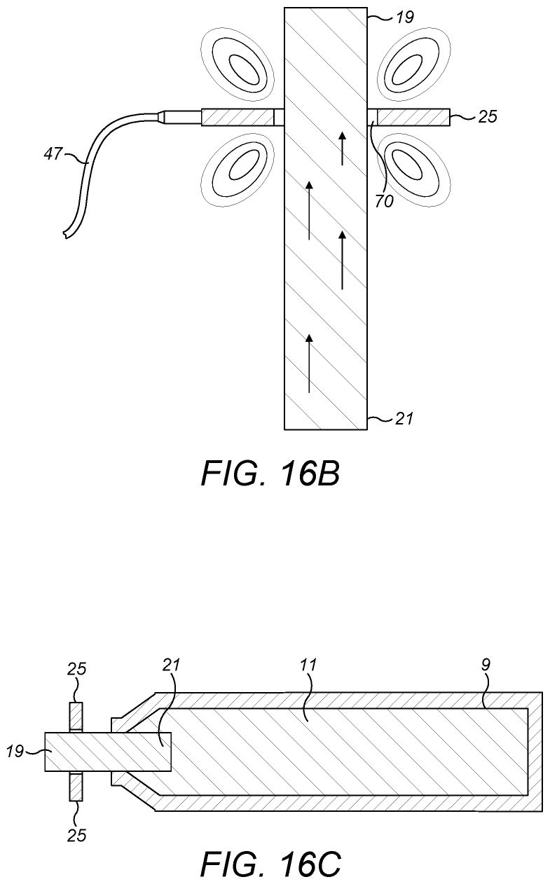

FIGS. 16a to 16c show an alternate heater arrangement in which a ring shaped heater 25 surrounds the second wick portion 19.

FIG. 16a shows a diagram of the heater ring 25 surrounding the second wick portion 19. The heater ring 25 is connected to a power supply in the main body 3 of the electronic cigarette by a wired connection 47. The aperture 70 in the ring has a diameter larger than the cross-section of the substantially cylindrical second wick portion 19 such that the second wick portion 19 can be inserted into the ring.

FIG. 16b shows a cross-sectional diagram of the arrangement of the heater 25 of FIG. 16a. The arrows indicate the liquid held in the wick 19, 21 diffusing from the first wick portion 21 located in the liquid store (not shown) toward the heated region of the second wick portion 19 where it is vaporised. The first 21 and second 19 wick portions form a single wick 19, 21.

FIG. 16c shows a cross-sectional diagram of the arrangement of the heater ring 25 in combination with the wick 19, 21 and the liquid store 9. The first wick portion 21 extends into the liquid store 9 it absorbs liquid 11 contained therein and wicks the liquid to the second wick portion 19. The heater ring 25 heats and vaporises the liquid held in the region of the second wick portion 19 proximal to the heater ring 25.

The heater ring 25 is advantageous as it provides an open structure which does not block the generated vapour from diffusing away from the heater 25. The heater ring 25 could be a ceramic or metal heater. The heater ring 25 need not be a complete ring, but could rather be an incomplete ring of a ‘C’ shape.

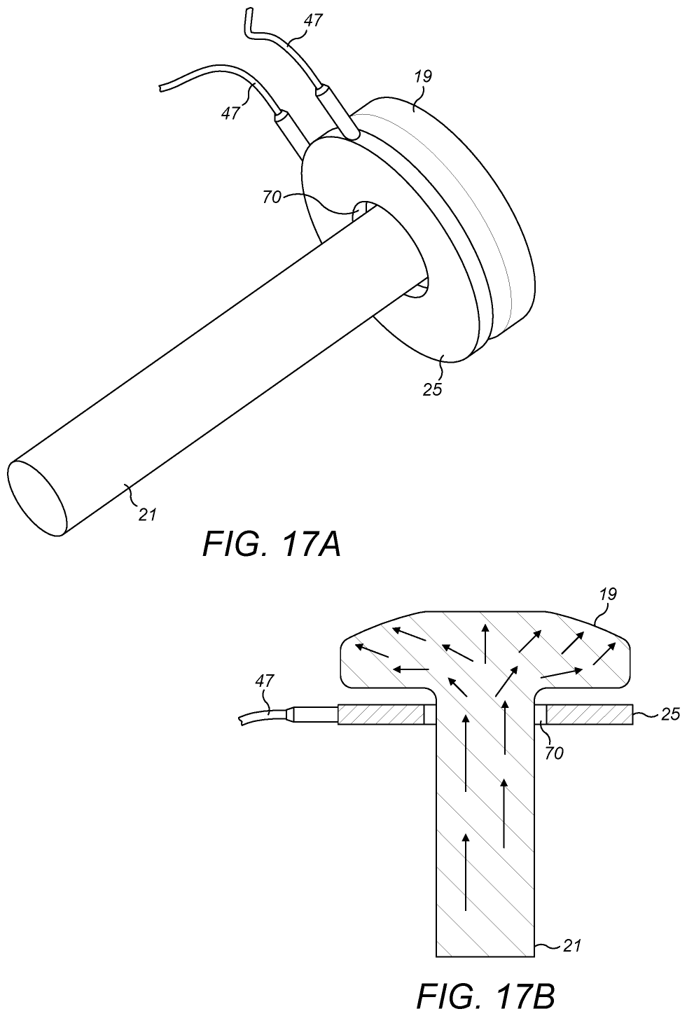

FIGS. 17a and 17b show an alternate wick arrangement that can be used with the heater ring 25 described with reference to FIGS. 16a, 16b and 16c. In this example the first 21 and second 19 wick portions form a single wick 19, 21 which has a ‘mushroom’ or ‘T’ type cross-sectional shape in the axial direction of the wick. The second wick portion 19 is wider than the first wick portion 21. The diameter of the wider end of the wick substantially matches the width of the heater ring 25 such that the wider end of the wick is aligned with the heater 25. That is, the second wick portion 19 has a wider diameter than the first wick portion 21 and the aperture 70 in the heater ring 25. The second wick portion 19 is disc-shaped and dimensioned to match the external diameter of the heater ring 25. The first wick portion 21 is smaller in diameter than the aperture 70 in the heater ring 25 such that it can pass through the aperture and extend into the liquid store 9.

As shown by the arrows in FIG. 17b, the liquid 11 in the liquid store 9 is wicked through the first wick portion 21 to the disc-shaped second wick portion 19 where it is heated and vaporised by the heater 25.

This arrangement is advantageous as it increases the interaction area between the heater 25 and the wick. This heater arrangement would be suited to the electronic cigarette described with reference to FIG. 5, with the disc-shaped portion of the wick arranged within the main body 3 of the electronic cigarette.

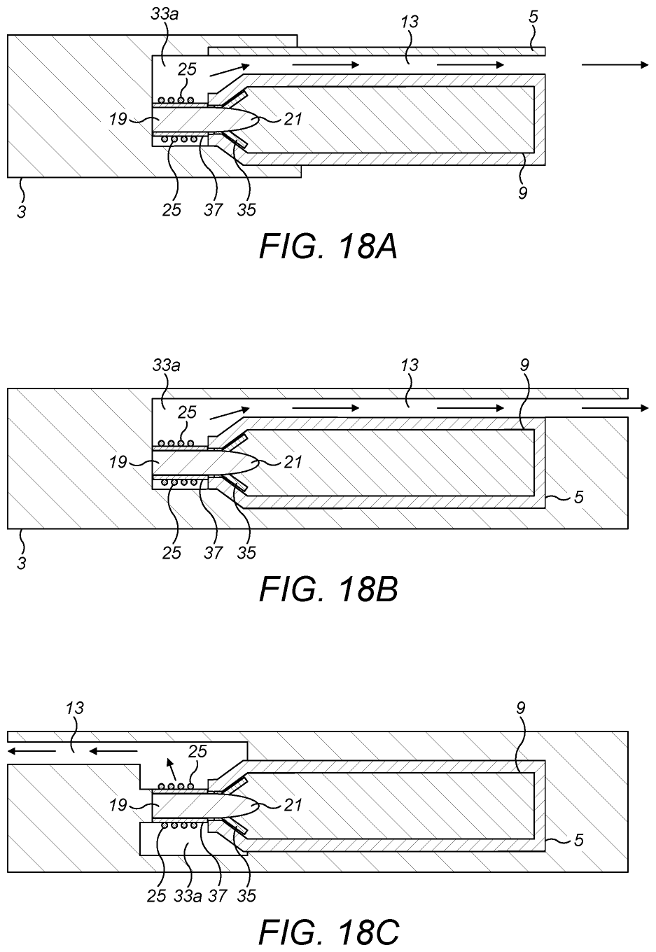

FIG. 18a shows a conceptual cross-sectional diagram of an arrangement of the main body 3 of the electronic cigarette and the cartridge 5 corresponding to that of FIGS. 1 to 5. The cartridge 5 is engaged with the main body 3 such that the second wick portion 19 is connected to the heater 25 and the first wick portion 21 extends into the liquid store 9 of the cartridge 5. Liquid 11 in the cartridge 5 is absorbed by the first wick portion 21 and wicked to the second wick portion 19 where it is vaporised by the heater 25. The generated vapour diffuses from the heater 25 and wick into the vapour cavity 33a. When the user draws on a mouthpiece of the cartridge 5 (not shown), at an end of the cartridge opposite the end engaged with the heater, the vapour is drawn through the vapour tube 13 integrated into, and running along the length of, the cartridge 5.

FIG. 18b shows a conceptual cross-sectional diagram of an alternate arrangement of the main body 3 of the electronic cigarette and the cartridge 5.

In this example the electronic cigarette functions in substantially the same way as that of FIG. 18a. The main differences are that the cartridge 5 is received and held within the main body 3 of the electronic cigarette rather than being connected to an end of the main body 3, and the vapour tube 13 is defined between an outer sidewall of the cartridge 5 and an inner sidewall of the main body 3. To accommodate this arrangement, the mouthpiece (not shown) is formed as part of the main body 3 of the electronic cigarette, rather than as part of the cartridge 5.

FIG. 18c shows a conceptual cross-sectional diagram of a further alternate arrangement of the main body 3 of the electronic cigarette and the cartridge 5. In this example the electronic cigarette is arranged substantially in the same manner as FIG. 18b, the difference being that the vapour tube 13 runs through the main body 3 of the electronic cigarette away from the cartridge 5 rather than alongside it. In this case the mouthpiece (not shown) is formed as part of the main body 3 of the electronic cigarette but at an end opposite to the end portion in which the cartridge 5 is held.

The arrangements described with reference to FIGS. 18a, 18b and 18c are compatible with any of the previously described electronic cigarette arrangements. In some examples the wick is attached to the cartridge 5 and received in the heater 25; in other examples the wick 19, 21 is attached to the heater 25 and received in the cartridge 5. The arrangements of FIGS. 18a, 18b and 18c are compatible with either of these arrangements.

Moreover, any of the aforementioned features in the various examples throughout the description can be integrated into any of the other examples where appropriate.

1. An electronic cigarette comprising:
a power supply portion comprising electrical circuitry and a heater, and
a replaceable cartridge comprising a liquid store;
wherein the power supply portion further comprises a fluid transfer element having an elongated shape, the fluid transfer element comprises a first wicking part extending outwardly from the power supply portion as a free end and a second wicking part configured to deliver liquid to the heater for vaporization, and
wherein the power supply portion further comprises a seating configured to fixedly attach to the second wicking part of the fluid transfer element and wherein the first wicking part is configured to extend into the liquid store when the power supply portion is connected to the replaceable cartridge, and wherein the fluid transfer element is removable from the seating of the power supply portion and the heater such that the fluid transfer element can be replaced; and
wherein the replaceable cartridge is removably coupleable to the power supply portion such that the first wicking part can be engaged and disengaged from the liquid store and, when disengaged, the fluid transfer element is a part of the power supply portion.

2. The electronic cigarette of claim 1, wherein the fluid transfer element is an elongated wick, and the first wicking part and the second wicking part are respectively located at two opposite distal ends of the elongated wick.

3. The electronic cigarette of claim 1, wherein the heater at least partially surrounds the second wicking part of the fluid transfer element.

4. The electronic cigarette of claim 1, wherein the replaceable cartridge has a housing and wherein a first end of the housing is configured as a first connection portion;
the power supply portion has a housing and wherein a first end of the housing of the power supply portion is configured as a second connection portion; and
the first connection portion of the replaceable cartridge is configured to connect to the second connection portion of the power supply portion.

5. The electronic cigarette of claim 4, wherein the second connection portion is configured as a free end protruding from the power supply portion into which the first connection portion of the replaceable cartridge is received.

6. The electronic cigarette of claim 5, wherein the second connection portion is tubular and extends at least partially over the first wicking part.

7. The electronic cigarette of claim 4, wherein the first connection portion is configured as a free end, protruding from the housing of the replaceable cartridge into which the second connection portion of the power supply portion is received.

8. The electronic cigarette of claim 1, wherein there is a gap between the second wicking part and the heater.

9. The electronic cigarette of claim 1, wherein the power supply portion further comprises a vaporization chamber, and wherein the replaceable cartridge further comprises a flow tube extending through the liquid store to a mouthpiece such that vapour can pass from the vaporisation chamber to the mouthpiece.

10. The electronic cigarette of claim 1, wherein the replaceable cartridge further comprises a closable opening configured to be opened upon engagement with the first wicking part of the fluid transfer element and wherein the closable opening of the replaceable cartridge is closed when the replaceable cartridge is disconnected from the power supply portion.

11. The electronic cigarette of claim 10, wherein the closable opening comprises a valve, wherein the valve is biased to a closed position.

12. The electronic cigarette of claim 11, wherein the valve comprises:
a channel extending into the liquid store from the closable opening with at least one aperture in a housing of the channel arranged to provide a fluid connection between the channel and the liquid store, a closing member and a biasing member arranged to bias the closing member to close the closable opening, wherein the channel is arranged to receive the first wicking part such that receiving the first wicking part pushes the closing member inward to the liquid store and compresses the biasing member, such that liquid can flow from the liquid store by the at least one aperture to the first wicking part received in the channel.

13. The electronic cigarette of claim 1, wherein the liquid store comprises a porous element, wherein the porous element is arranged to transfer liquid to the fluid transfer element.

14. The electronic cigarette of claim 1, wherein the heater and the fluid transfer element are mounted on a support that is removable from the seating of the power supply portion such that the fluid transfer element and the heater can be replaced.
